(19) United States
(12) Patent Application Publication
(10) Pub. No.: US 2026/0323238 A1
(43) Pub. Date: Oct. 15, 2026

(54) AUDIO AUGMENTED REALITY OBJECT REPRODUCTION APPARATUS, AND INFORMATION TERMINAL SYSTEM

(71) Applicant: Maxell, Ltd., Kyoto (JP)

(72) Inventors: Sadao TSURUGA, Kyoto (JP); Yasunobu HASHIMOTO, Kyoto (JP); Kazuhiko YOSHIZAWA, Kyoto (JP); Kazuyuki TAKIZAWA, Kyoto (JP)

(21) Appl. No.: 18/853,443

(22) PCT Filed: Apr. 4, 2022
(86) PCT No.: PCT/JP2022/017058

§ 371 Date: Oct. 2, 2024

(51) Int. Cl. H04S 7/00; G06F 3/01; G06F 3/04815; G06F 3/16; H04R 1/02; H04R 5/027

(52) U.S. Cl. CPC H04S 7/304; G06F 3/04815; G06F 3/167; H04R 1/028; H04R 5/027; G06F 3/012; G06F 3/013; H04R 2499/15; H04S 2400/11; H04S 2400/15

(57) ABSTRACT

An audio augmented reality object reproduction apparatus is apparatus that capable of mapping an object in virtual space. Also, the audio augmented reality object reproduction apparatus includes a processor that performs predetermined processing. Also, the processor of the audio augmented reality object reproduction apparatus, as an example, is able to perform processing that maps an information terminal or an application of the information terminal as an object, to a location in the virtual space corresponding to a location of the information terminal, based on a sound output and input from the information terminal, such as smartphones, appropriate wearable apparatus, etc.

### TECHNICAL FIELD

This invention relates to an audio augmented reality object reproduction apparatus and an information terminal system using an audio augmented reality object reproduction apparatus.

### BACKGROUND ART

Traditionally, an example of an audio augmented reality object reproduction apparatus, which is an audio augmented reality object reproduction apparatus that is worn on the user's head, outputs audio based on stereophonic technology from an audio output device such as a speaker, and displays various information on a display screen in front of the user's eyes, is known.

Here, PTL 1 discloses technology related to stereophonic technology. That is, PTL 1 discloses a stereophonic signal reproduction device that generates and reproduces stereophonic signal, and that, comprises a first processing section, after performing a Fourier transform along an azimuth angle on a head transfer function measured at a first distance, performs a transformation process from said first distance to a second distance using a Hankel function, and further generates a head transfer function at said second distance by performing an inverse Fourier transform with the order of said Hankel function being a variable, and a second processing section generates the stereophonic signal by applying the head transfer function at the second distance as a filter to the input acoustic signal.

And the technology of PTL 1 is said to be effective of enabling high-quality stereophonic sound reproduction, by suppressing quality degradation caused by discontinuity points, even when using the method of synthesizing HRTFs at arbitrary distances on a horizontal plane. In addition, PTL 1 discloses that it is possible to realize a stereophonic signal reproduction device with a high sense of presence in the horizontal plane, where human perception accuracy is high.

On the other hand, PTL 2 discloses an audio processing device. That is, PTL 2 discloses an audio processing device comprises a microphone array having at least two or more channels of microphone elements, a band splitter that splits the signal from the microphone array into multiple frequency bands for each channel, a sound source localization unit that estimates the sound source direction from the band-divided split bandwidth signal, a sound source separation unit that emphasizes above split bandwidth signal for each of the above estimated sound source directions, a sound source overlap determination unit determines whether the split bandwidth signal is from multiple or a single sound source using the above emphasized split bandwidth signal and the above estimated sound source direction information, and a sound source search unit performs a sound source search using the signal that is determined to be a split bandwidth signal from the above-mentioned singular sound source.

The technology of PTL 2 determines whether multiple sound sources overlap and uses only the split bandwidth signal of a single sound source is sounding for sound source localization, and does not use bandwidth components in which multiple sound sources overlap and the directional information of the sound source is lost. As a result, the technology of PTL 2 is said to be able to grasp the direction in which audio or music is sounding with high accuracy.

### CITATION LIST

### Patent Literature

PTL 1: JP 2018-64227 A
PTL 2: JP 2006-227328 A

### SUMMARY OF INVENTION

### Technical Problem

As an example, the following method can be considered, as a way of using the audio augmented reality object reproduction apparatus by a user. Thus, the user maps an object (information terminal and application) as a virtual object in the virtual space of the audio augmented reality object reproduction apparatus, and performs operation of the mapped object using the audio augmented reality object reproduction apparatus. However, for example, in cases where the user's vision of the outside world is limited, it is considered that the user may not be able to perform easy mapping and lack user convenience. Note that, it is considered that the PTL 1 and PTL 2 described above do not disclose such a mapping technique.

Therefore, the purpose of the present invention is to provide an audio augmented reality object reproduction apparatus, which improves to user convenience and be able to easily perform mapping, and an information terminal system using this audio augmented reality object reproduction apparatus.

### Solution to Problem

According to a first aspect of the present invention, there is provided the following audio augmented reality object reproduction apparatus. The audio augmented reality object reproduction apparatus is able to map an object in virtual space. The audio augmented reality object reproduction apparatus includes a processor. The processor, based on a sound output and input from an information terminal, maps the information terminal or an application of the information terminal as an object, to a location in the virtual space corresponding to a location of the information terminal.

According to a second aspect of the present invention, there is provided the following information terminal system. The information terminal system includes one or more information terminals, and an audio augmented reality object reproduction apparatus capable of mapping an object in virtual space. The audio augmented reality object reproduction apparatus includes a processor. The processor, based on a sound output and input from the information terminal, maps the information terminal or an application of the information terminal as an object, to a location in the virtual space corresponding to a location of the information terminal.

### Advantageous Effects of Invention

According to the present invention, it provides an audio augmented reality object reproduction apparatus, which improves to user convenience and be able to easily perform mapping, and an information terminal system using this audio augmented reality object reproduction apparatus.

### BRIEF DESCRIPTION OF DRAWINGS

FIG. 1 is a block diagram used to illustrate an example of a head mounted display configuration in accordance with the first embodiment.

FIG. 2 is a diagram used to illustrate an example of a communication connection with an information terminal.

FIG. 3 is a diagram used to illustrate an example of a head mounted display structure.

FIG. 4 is a diagram used to illustrate an example of a head-mounted display structure.

FIG. 5 is a diagram used to illustrate an example of how a user can map an object.

FIG. 6 is a diagram used to illustrate an example of how a user can map an object.

FIG. 7 is a diagram used to illustrate an example of how a user can map an object.

FIG. 8 is a diagram used to illustrate the sound sources of the sound heard during mapping.

FIG. 9 is a diagram used to illustrate the sound sources of the sound heard after mapping.

FIG. 10 is a diagram used to illustrate the relationship between virtual sound source in virtual space and stereophonic sound.

FIG. 11 is a diagram used to illustrate the location Of the virtual sound source in the local coordinate system.

FIG. 12 is a diagram used to illustrate the location of the virtual sound source in the world coordinate system.

FIG. 13 is a flowchart used to illustrate an example of the mapping process.

FIG. 14 is a flowchart used to illustrate an example of the mapping process.

FIG. 15 is a flowchart used to illustrate an example of the mapping process.

FIG. 16 is a flowchart used to illustrate an example of the voice operation process.

FIG. 17 is a flowchart used to illustrate an example of the voice operation process.

FIG. 18 is a flowchart used to illustrate an example of the voice operation process.

FIG. 19 is a diagram used to illustrate an example of data input and output between the head mounted display in sound operation and the information terminal.

FIG. 20 is a block diagram used to illustrate an example configuration of an audio augmented reality object reproduction apparatus in accordance with the second embodiment.

### DESCRIPTION OF EMBODIMENTS

Hereinafter, the form for implementing the present invention is illustrated in accordance with the drawings. However, the following description is one of the forms for implementing the invention and does not limit its application to other configurations and forms in which similar processing is possible. The mapping technology of the present invention can contribute to the Sustainable Development Goals (SDGs) proposed by the United Nations, “9. Industry, Innovation, and Infrastructure.

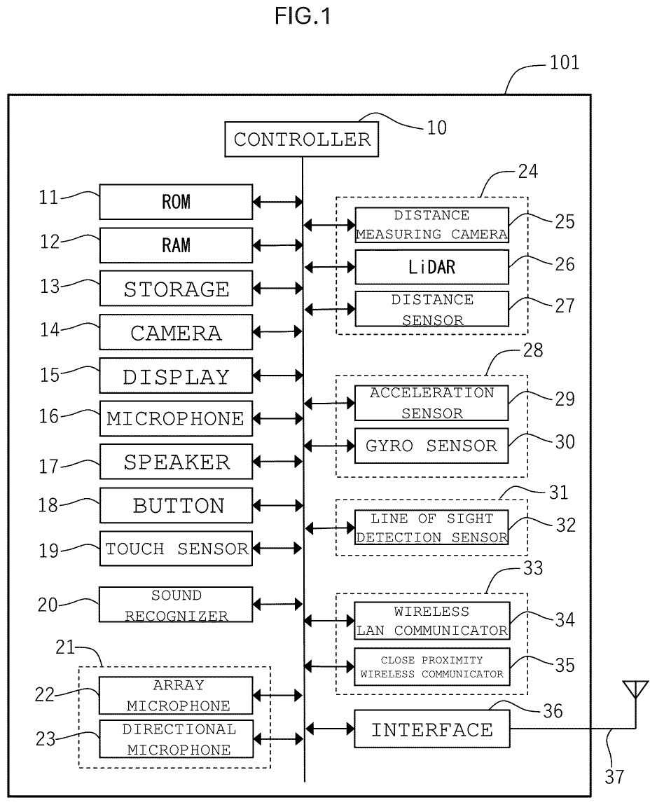

First, with reference to FIG. 1, as an example of an audio augmented reality object reproduction apparatus, an example of a head mounted display (sometimes described as HMD) will be described. Note that, the audio augmented reality object reproduction apparatus is an apparatus that can map an object using sound of the object and reproduce the sound of the mapped object. FIG. 1 is a block diagram used to explain an example configuration of an HMD. According to the first embodiment, the HMD 101 can map an object on a virtual space and generate an icon of the mapped object. In addition, the user can select the generated icons and operate the mapped object.

As shown in FIG. 1, HMD 101 is equipped with controller 10, ROM 11, RAM 12, storage 13, camera 14, display 15, microphone 16, speaker 17, buttons 18, and touch sensor 19.

Controller 10 (processor) controls the entire HMD 101 according to a predetermined operating program. Controller 10 sends and receives such as various commands and data to and from each configuration block in the HMD 101, via the system bus, which is a data communication path. The controller 10 may be an entity that performs the prescribed processing, and is composed of a CPU (Central Processing Unit), for example, but may also be composed of a GPU (Graphics Processing Unit) or other semiconductor device.

ROM 11 is composed of a flash ROM or other suitable storage device and stores data such as programs related to the operation and the performing process of the HMD 101. Ram 12 is the memory used by when controller 10 performs prescribed processing. Storage 13 can be composed of a hard disk drive (HDD: Hard Disk Drive) or other appropriate memory device, and can store data.

The camera 14 is provided at an appropriate location so that external images can be acquired. The camera 14 may, for example, be provided so that information outside the user's field of view can be acquired.

Display 15 (display) is provided on the front side and displays images. The display 15 may, for example, display images acquired by the camera 14, and the user wearing the HMD 101 may obtain information visually, by viewing the images acquired by the camera 14 on the display 15. The display 15 may also display icons generated by the mapping process, as will be explained in detail later, but the display 15 may also display other information (e. g., information about the output volume from the HMD 101, information acquired from outside via wireless communication, etc.) as appropriate.

Note that, the display 15 can be of any appropriate structure. The display 15 may, for example, be non-transmissive or transmissive. Also, the HMD 101 may, for example, be structured to have one display 15 in front of each of the user's two eyes, or one display 15 that covers both of the user's eyes.

Microphone 16 is a sound input apparatus, and in this embodiment, it is provided at an appropriate position so that the voice of the user wearing the HMD 101 can be input. The microphone 16 may be provided, for example, via a member that extends to the mouth.

Speaker 17 is an audio output apparatus, and outputs information by audio. Speaker 17 is provided at an appropriate position so that the user can listen to the output audio. Note that, an audio output apparatus different from the speaker 17 may be used, for example, headphones may be provided as an audio output apparatus.

The HMD 101 may be configured so that the user can perform various operations such as volume and picture quality adjustment and communication settings by means of buttons 18 and touch sensors 19. The desired operation may be achieved by pressing the button 18 corresponding to the user's desired operation, and the position and number of buttons 18 may be set as appropriately. The touch sensor 19 is provided as appropriate to be able to detect the operation of the user pressing the icons and other items displayed on the display 15.

The HMD 101 is equipped with a sound recognizer 20. the sound recognizer 20 is configured to including circuitry and the like for processing sound recognition. Here, programs and data used for sound recognition are placed in appropriate memory apparatus such as ROM 11 and storage 13. Note that, in the processing of sound recognizer 20, known methods may be used, for example, the processing may analyze and recognize the input sound using an acoustic model or a language model.

The HMD 101 is equipped with a sound inputter 21. The sound inputter 21 is configured, for example, as a sound input apparatus to which sound output from the information terminal 102 is input in the mapping process described below. Sound inputter 21 is, as an example, a sound input apparatus that can acquire information on the orientation to the source of the sound, and can be configured with, for example, an array microphone 22 or a directional microphone 23, as will be described in detail later.

The HMD 101 is equipped with a distance measurer 24. The distance measurer 24, for example, can be configured by a sensor that measures the distance to the information terminal 102 in the mapping process described below. The distance measurer 24, for example, can be configured by such as a distance measuring camera 25 (as an example, a stereo camera), a LIDAR 26, and a distance sensor 27 that is different from these sensors and can measure the distance to the information terminal 102 accordingly. Note that, the distance measurer 24 may be configured with one or more sensors. Also, the distance measurer 24 may be configured with one or more types of sensors.

The HMD 101 is equipped with a head tracker 28. The head tracker 28 is used to detect the inclination of the user's head when the HMD 101 is worn. The head tracker 28, for example, can be configured with a sensor, such as an acceleration sensor 29 and a gyro sensor 30. Note that, the head tracker 28 may be configured with one or more sensors. Also, the head tracker 28 may be configured with one or more types of sensors.

The HMD 101 is equipped with an eye tracker 31. The eye tracker 31 is used to detect the direction of the user's line of sight when the HMD 101 is worn. The eye tracker 31, for example, can be configured with a sensor such as line of sight detection sensor 32. The eye tracker 31 may be configured with one or more sensors. Also, the eye tracker 31 may be configured with one or more types of sensors.

The HMD 101 is equipped with a communication processor 33. The communication processor 33 is configured to including circuitry and the like that performs communication processing (e. g., signal processing) in wireless communication, in this embodiment, the HMD 101 is equipped with a wireless LAN communicator 34 that performs communication processing when communicating by wireless LAN, and a close proximity wireless communicator 35 that performs communication processing when communicating by close proximity wireless communication.

The HMD 101 is also equipped with an interface 36 used for communication. The HMD 101 can send and receive data to and from the outside world, by performing wireless communication with the outside world via the interface 36. Here, the HMD 101 may be equipped with an antenna 37 used for wireless communication. Also, it may be provided with a apparatus used for wireless communication, such as a wireless adapter.

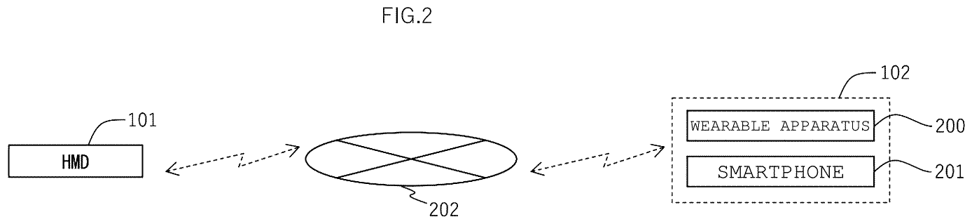

Next, with reference to FIG. 2, an example of a wireless communication mode will be described. As shown in FIG. 2, the HMD 101 can, as an example, communicate with the information terminal 102 via the network 202. Here, in the embodiment, the information terminal 102 is an apparatus capable of outputting sound, and the information terminal 102 includes, as an example, a wearable apparatus 200 and a smartphone 201.

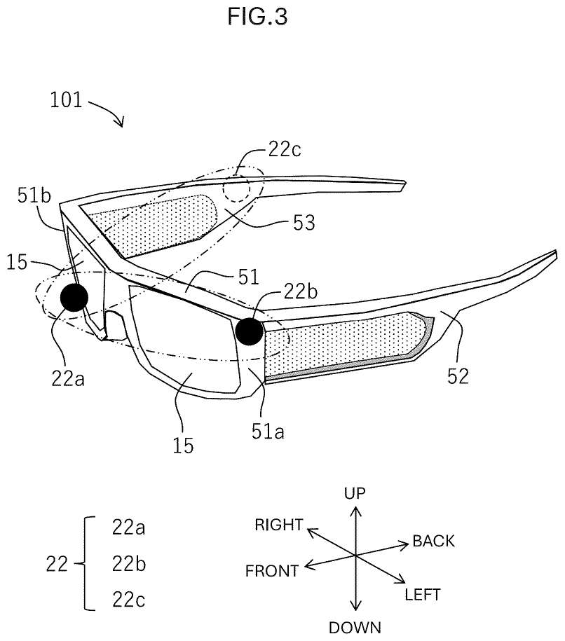

Next, with reference to FIG. 3, an example of the structure of HMD 101 in which sound inputter 21 is configured with array microphone 22 will be described. In the example of FIG. 3, the HMD 101 has a structure having a spectacle shape, but the structure of the HMD 101 is not limited to this example and can be changed as appropriate. Here, it is explained, the front-back, left-right and up-down directions shown in FIG. 3 will be used as the standard.

As shown in FIG. 3, HMD 101 includes a front side (front side) frame section 51, a left frame section 52, and a right frame section 53. Two displays 15 are attached to the front frame section 51 so that they are positioned in front of the user's left and right eyes, respectively, when worn.

The left frame section 52 extends rearward from the left end portion 51a of the front frame section 51 and is located on the left side of the user's head when worn. A speaker 17, which is not illustrated in FIG. 3, is attached to the left frame section 52 to output sound to the user's left ear. Similarly, the right frame section 53 extends rearward from the right end portion 51b of the front frame section 51 and is located on the right side of the user's head when worn. A speaker 17, which is not illustrated in FIG. 3, is attached to the right frame section 53 so as to output sound to the user's right ear.

Also, the HMD 101 is provided with a first microphone 22a, a second microphone 22b, and a third microphone 22c, which are microphones configure the array microphone 22. In the example shown in FIG. 3, the first microphone 22a and the second microphone 22b are located at the left end portion 51a and the right end portion 51b of the front frame section 51. In other words, the first microphone 22a is located at the lower right end portion of the front frame section 51 and the second microphone 22b is located at the upper left end portion of the front frame section 51. Also, the third microphone 22c is located on the outside (right side) of the right frame section 53. Note that, contrary to the arrangement shown in FIG. 3, the first microphone 22a may be located at the lower left end portion of the front frame section 51, the second microphone 22b may be located at the upper right end portion of the front frame section 51, and the third microphone 22c may be located outside (left side) of the left frame section 52. Also, the first microphone 22a and the second microphone 22b, in the edge portion of the front frame section 51, may be located on the front side of the HMD 101 or on the left or right side.

By the first 22a and second 22b microphones arranged in this way, when sound is input, the direction of the sound source (with respect to the left/right and up/down directions) is identified based on the difference in the timing of the inputs to the first microphone 22a and second microphone 22b. Also, by the first microphone 22a and third microphone 22c, when sound is input, the direction of the sound source (with respect to the front and back directions) is identified based on the difference in the timing of the inputs to the first microphone 22a and third microphone 22c. Therefore, with the array microphones 22 arranged in this way, the HMD 101 can easily identify the direction of the sound source.

Here, with respect to the arrangement described above, it is preferable that each microphone (22a, 22b, 22c) of the array microphone 22 be arranged so that the distance between the first microphone 22a and the second microphone 22b, and the distance between the first microphone 22a and the third microphone 22c are almost identical. It can improve the accuracy of identifying the direction of the sound source, by this structure of positional relationships.

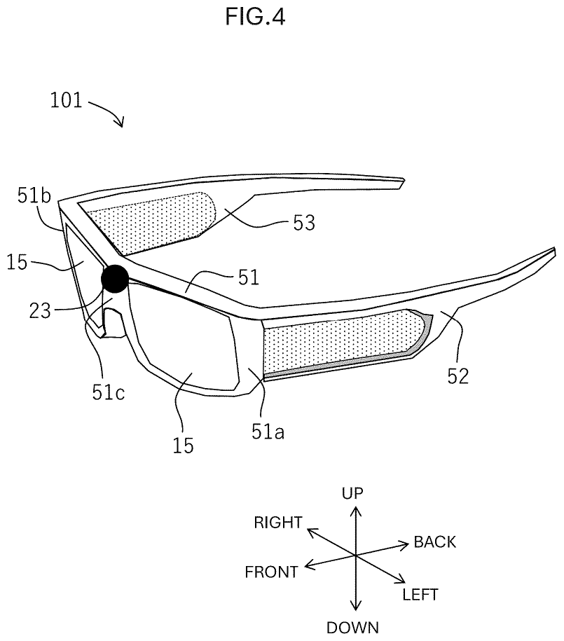

Next, with reference to FIG. 4, an example of the structure of HMD 101 in which sound inputter 21 is configured with a directional microphone 23 will be described. In the example of FIG. 4, as in FIG. 3, the HMD 101 has a structure having a spectacle shape, but is not limited to this structure. Here, the front-back, left-right and up-down directions shown in FIG. 4 will be used as a basis for explanation.

Similar to the configuration in the case of the array microphone 22 described above, the HMD 101 includes a front side (front side) front frame section 51, a left frame section 52, and a right frame section 53. The display 15 is attached to the front frame section 51, and speaker 17, which is not illustrated in FIG. 4, is attached to the left frame section 52 and the right frame section 53.

In the example in FIG. 4, the directional microphone 23 is located at the upper end side of the center portion 51c of the front frame section 51. And, by using the directional microphone 23, the direction of the sound source can be identified. Note that, the directional pattern of the microphone may be set as desired, as long as the direction of the sound source can be identified. Also, in this example, the directional microphone 23 is positioned at the upper end side of the center portion 51c of the front frame section 51, but the directional microphone 23 may be positioned at other locations. Also, the number of directional microphones 23 may be provided in plurality instead of singly, but the number of microphones may be reduced, for example, by appropriately switching the directional pattern of the microphones.

While HMD 101 with array microphone 22 and HMD 101 with directional microphone 23 were described above, HMD 101 may be constructed as follows. For example, the HMD 101 may be provided with both the array microphone 22 and the directional microphone 23, and the HMD 101 may identify the direction of the sound source based on the sound data input to both the array microphone 22 and the directional microphone 23. Also, the HMD 101 may be provided with a position adjustment mechanism to adjust the position of the microphones. The position adjustment mechanism may be, as an example, a mechanism that allows the position of the microphone to be adjusted by sliding the microphone along the frame. Also, the HMD 101 may have a structure that can be folded or unfolded between the frames.

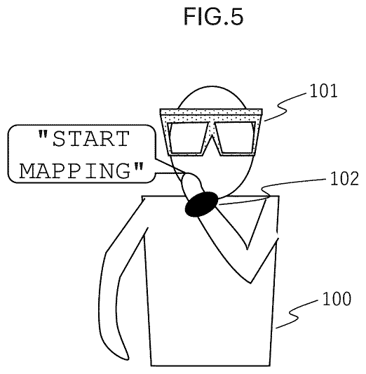

Next, with reference to FIGS. 5 through 7, an example of how a user can map an object is described. In the example in FIGS. 5 through 7, the object of the mapping is the information terminal 102 (in detail, the wearable apparatus 200, which is an example of the information terminal 102). And, in this example, the information terminal 102 is capable of sound input and sound output, and by recognizing the sound to be input, it transitions to a mode in which mapping is performed (mapping mode).

As shown in FIG. 5, a user wearing the HMD 101 (operator 100 in FIG. 5) commands the HMD 101 and wearable apparatus 200 to start mapping by inputting a sound to start mapping into the microphone 16 of the HMD 101 and the wearable apparatus 200. When the user inputs sound by, for example, uttering a voice commanding the start of mapping, “start mapping,” the HMD 101 and wearable apparatus 200 will transition to the mapping mode based on the appropriate sound recognition.

Note that, although the example of transitioning the HMD 101 and the information terminal 102 to mapping mode at the same time was described, the respective information apparatuses (101 and 102) may be transitioned to mapping mode at different times. The user may, for example, make transition the information terminal 102 to mapping mode after transitioning the HMD 101 to mapping mode.

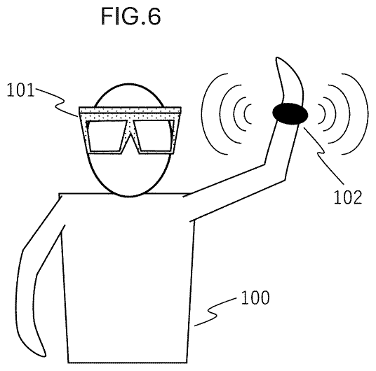

Next, as shown in FIG. 6, the user moves the wearable apparatus 200 to the position where he/she wants to register it, and causes the wearable apparatus 200 to output sound. Here, the user makes the wearable apparatus 200 output sound by using an appropriate method (e.g., key operation, screen touch, or voice input to the wearable apparatus 200).

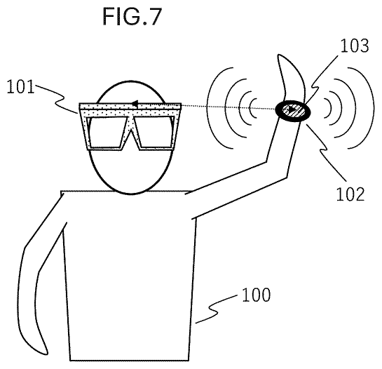

Then, as shown in FIG. 7, by sound from the information terminal 102 is input to the HMD 101 (in detail, the sound inputter 21 of the HMD 101), the HMD 101 performs the process of mapping this information terminal 102 in the virtual space, based on the input sound. Here, the HMD 101 identifies the orientation of the sound source (i.e., the information terminal 102) and calculates the distance to the sound source, based on the sound input to the sound inputter 21. Note that, the distance to the sound source may be calculated as appropriate using the data of the sound input to sound inputter 21 (e.g., data relating the loudness of the sound input to the distance to the sound source). Also, if the HMD 101 is equipped with a distance measurer 24, the results of the measurement of the distance to the information terminal 102 by the distance measurer 24 may also be used. By using the measurement results of the distance measurer 24, it improves the accuracy of mapping (particularly, the accuracy in the depth direction to the information terminal 102). Also, the HMD 101 may perform location detection of the information terminal 102 by wireless communication with the information terminal 102, and use the results of the location detection to perform mapping.

The HMD 101 then maps, as the object, the information terminal 102 (in this example, wearable apparatus 200) to the corresponding position in the virtual space, based on the sound source orientation and distance to the sound source, and places the virtual sound source 103 of the mapped object. Note that, in this explanation, the information terminal 102 was considered the object of mapping, but an app owned by the information terminal 102 may also be the object of mapping. In this case, the mapping process of the application is performed by causing the information terminal 102 having the object application to output a sound when the object application is started or used.

The HMD 101 can then generate an icon indicating the mapped object and display the generated icon on the display 15. Here, although the HMD 101 can display the icon at an appropriate location on the display 15, as an example, the HMD 101 can display the icon of the object at a location corresponding to the location of the mapped object in the virtual space. Note that, the HMD 101 may display information regarding the name indicating the object (e. g., textual information such as “wearable apparatus” when the object is the wearable apparatus 200) with the icon.

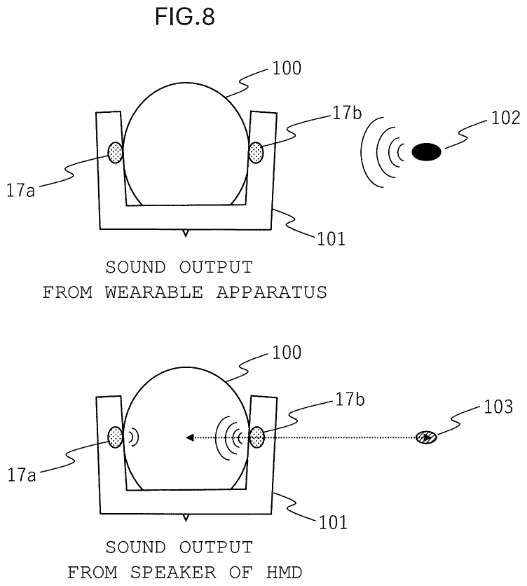

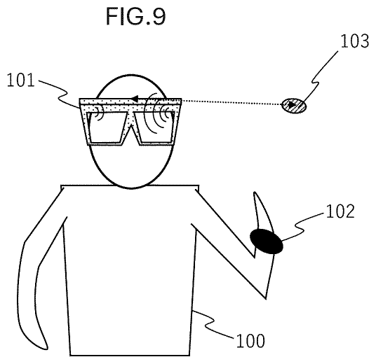

Here, with reference to FIGS. 8 and 9, an example of the sound output of the HMD 101 during and after mapping is described.

At the time of mapping the object, as shown in FIG. 8, the user can hear sound from information terminal 102 (in this example, wearable apparatus 200) and sound from speaker 17 of HMD 101. Here, speaker 17 of the HMD 101 (in FIG. 8, speakers 17a and 17b on the left and right sides, respectively) outputs sound with the position considered to be the same as the information terminal 102 (i.e., the position obtained based on the orientation of the information terminal 102 and the distance to the information terminal 102) as the virtual sound source 103. Therefore, sound similar to that heard from the information terminal 102 (i.e., sound as if heard from the position of the virtual sound source 103) is output from the speaker 17 of the HMD 101. Therefore, the user can easily check whether the mapping is being performed properly by comparing the sound output from the speaker 17 with the sound actually heard from the information terminal 102.

Note that, after mapping, as shown in FIG. 9, even if the position of the information terminal 102 (in this example, the wearable apparatus 200) is changed, the HMD 101 will output sound that can be heard from the position of the virtual sound source 103.

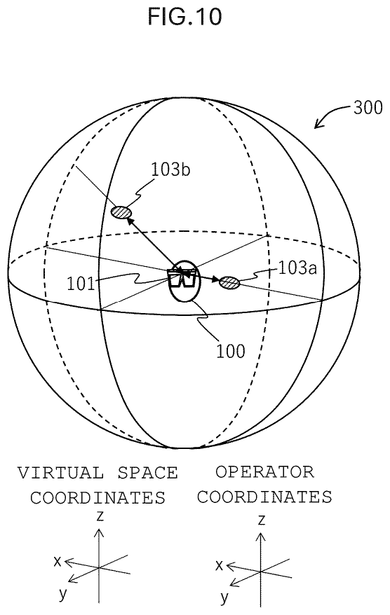

Here, with reference to FIG. 10, the relationship between the virtual sound source 103 in the virtual space 300, which is the space in which the object is mapped, and stereophonic sound, is explained. Stereophonic sound is the reproduction so that even the direction and distance of sound can be felt, in this embodiment, the HMD 101 expresses stereophonic sound by placing the virtual sound source 103 in the virtual space 300 and calculating whether the sound emitted from it reaches the ears.

In other words, by the user's operation as explained above, the HMD 101 maps the object in the virtual space 300, which is a coordinate space centered on the position of the user (in the figure, the operator 100 wearing the HMD 101), and places virtual sound sources (103a, 103b) at the mapped positions in the virtual space. The HMD 101 then expresses stereophonic sound by outputting appropriate sound based on the direction and distance of the virtual sound sources (103a, 103b). Here, the HMD 101 can adjust the sound to match the sound output apparatus and output the adjusted sound. For example, if the sound output apparatus is the speaker 17, the HMD 101 can output the sound adjusted to match the speaker 17. For example, if the sound output apparatus is headphone, the HMD 101 can output sound adjusted to match the headphone.

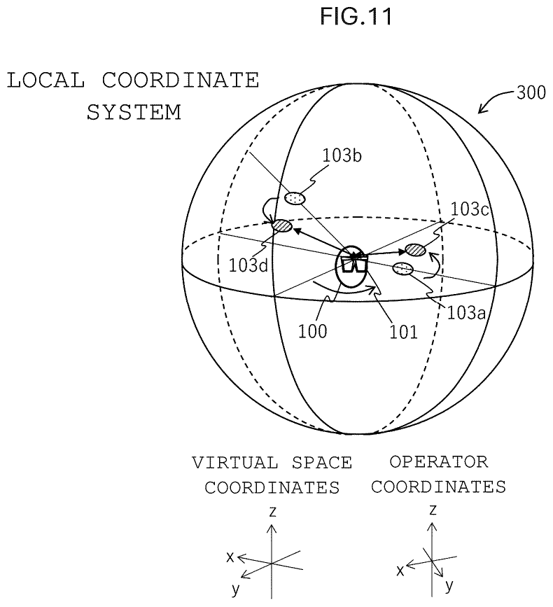

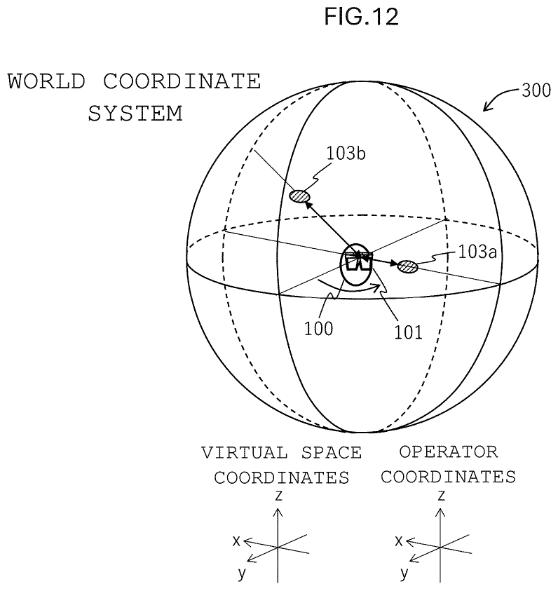

Also, in this embodiment, the HMD 101 can map the object to the virtual space 300 in the coordinate system (local or world coordinate system) selected by the user. Here, with reference to FIGS. 11 and 12, the positions of the virtual sound source in the respective coordinate systems will be explained, when the user moves etc.

First, with reference to FIG. 11, the case where the virtual space 300 is a local coordinate system, will be explained. A local coordinate system is a coordinate system in which the positions of the virtual sound sources (103a, 103b) move with the user (operator 100 in the figure), and the virtual sound sources (103a, 103b) move in response to the user's movements, in the case of the local coordinate system.

As shown in FIG. 11, for example, when a user wearing HMD 101 changes his/her orientation, the position of the mapped virtual sound sources (103a, 103b) changes to follow the changed user orientation. In the example in FIG. 11, by changing in the position of virtual sound source 103a, it will place virtual sound source 103c on the virtual space 300, and by changing in the position of virtual sound source 103b, it will place virtual sound source 103d on the virtual space 300. In this way, in the local coordinate system, the positions of the virtual sound sources (103a, 103b) move on the virtual space 300 so as to maintain the relationship of constant orientation and constant distance, the user's position and orientation (in other words, the position and orientation of the HMD 101) as the basis. Note that, in this process, head tracking may be used as an example. Also, as an example, a GPS receiver sensor may be provided in the HMD 101 and data based on GPS may be used.

Therefore, in the local coordinate system, even if the user wearing the HMD 101 changes direction or moves, the orientation of the virtual sound source as the basis on the user and the distance to the virtual sound source remain the same, and the HMD 101 outputs sound from the virtual sound source in which a constant orientation and constant distance relationship as the basis on the user.

In contrast, the world coordinate system is a coordinate system in which the positions Of the virtual sound sources (103a, 103b) are fixed, in the world coordinate system, the positions of the virtual sound sources (103a, 103b) do not change even if the user moves or otherwise. Therefore, as shown in FIG. 12, for example, if the user (operator 100 in the figure) changes direction, the orientation of the virtual sound sources (103a, 103b) as the basis the user, will change accordingly, and the HMD 101 will output sound from the virtual sound sources (103a, 103b) in different directions before and after the user changes direction. Therefore, unlike the local coordinate system, in the world coordinate system, the direction of the sound heard and the distance of the sound changes as the user changes direction or moves.

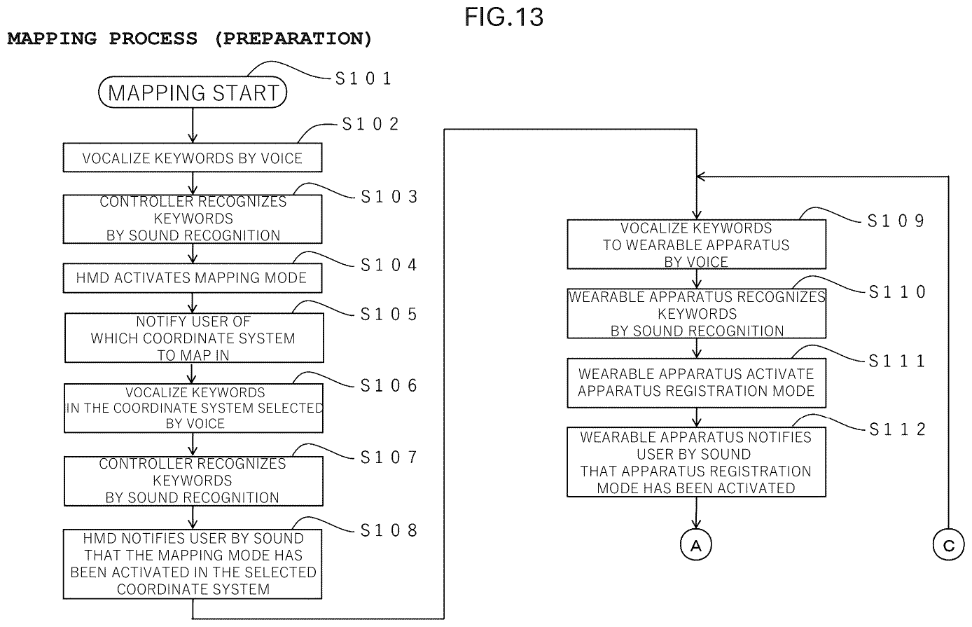

Next, the details of the mapping process are explained with reference to the flowcharts shown in FIGS. 13 through 15. FIGS. 13 through 15 are flowcharts used to explain an example of the mapping process.

As shown in FIG. 13, the HMD 101 waits until the sign the start of mapping by user (S101). Then, when the user vocalizes a voice signaling the start of mapping (e.g., the user vocalizes “start mapping”) (S102), controller 10 performs sound recognition to recognize the keyword signaling the start of mapping (S103). The HMD 101 (controller 10, in detail) then recognizes the keywords by sound recognition and activates the mapping mode, which is a mode for mapping the object (S104). Here, the HMD 101 outputs a notification sound to select whether to perform mapping in the local coordinate system or in the world coordinate system (S105). By the user then vocalizes the keywords to select which coordinate system the mapping should be performed in (e.g., the user vocalizes “local coordinate system”) (S106), the controller 10 recognizes the keywords for which coordinate system to use by performing sound recognition (S107). The HMD 101 then outputs a sound to notify the user that the mapping mode in the selected coordinate system has been activated (S108). Here, the HMD 101 outputs a voice, for example, “mapping mode starts in the local coordinate system”.

Note that, the keywords and other data used by HMD 101 for sound recognition in S101 to S108 above may be stored in advance in an appropriate memory apparatus such as storage 13.

Next, the user vocalizes a voice sign to the start of mapping, to the information terminal 102 (in this example, the wearable apparatus 200) (S109). The user vocalizes, for example, “Start registration. Here, wearable apparatus 200 recognizes the keywords by sound recognition (S110), as in the case of HMD 101 described above, and activates the apparatus registration mode, which is a mapping mode (S111). Here, the wearable apparatus 200 may output a sound to notify that the apparatus registration mode has been activated (S112). The wearable apparatus 200, for example, may output a sound saying, “The apparatus registration mode starts”.

Note that, as in the case described above, keywords and other data used by the information terminal 102 for sound recognition in S109 to S112 may be stored in advance in an appropriate memory apparatus of the information terminal 102. Also, in this example, an example in which the HMD 101 and the information terminal 102 are individually set to mapping mode was described, but the user may transition the HMD 101 and the information terminal 102 to mapping mode simultaneously by inputting voice to the HMD 101 and the information terminal 102 at the same timing.

Thus, in S101 through S112, preparations for the mapping process are made. Then, mapping is performed by the process described below.

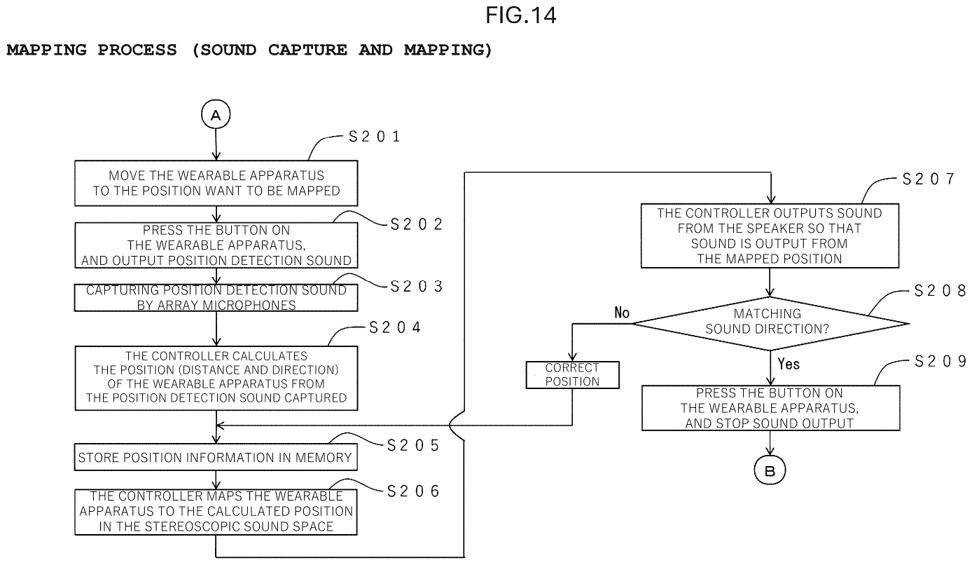

As shown in FIG. 14, first, the user moves the wearable apparatus 200 to the position to be mapped (S201). Then, the user presses a button on the wearable apparatus 200 to output the sound (position detection sound) of the object to be mapped (S202).

Here, when the object to be mapped is the information terminal 102 (in this example, the wearable apparatus 200), the user, as an example, causes the information terminal 102 to output sound related to the mapping mode. On the other hand, if the mapping object is an application owned by the information terminal 102, the user operates the information terminal 102 to run the object application and causes the information terminal 102 to output sound of the application.

Note that, the method of causing the information terminal 102 (in this example, the wearable apparatus 200) output sound, only needs to be able to output the sound appropriately, is not limited to the button pressing method, but can also be key operation, screen touches, voice input, or other methods.

Then, if sound is output from the information terminal 102 in S202, the HMD 101 captures the sound (position detection sound) via the sound inputter 21 (S203). Here, in this example, the sound inputter 21 is an array microphone 22, but it may be replaced by a directional microphone 23, for example.

The controller 10 then calculates the position (distance and orientation) f the wearable apparatus 200 from the captured sound (position detection sound) (S204). Here, controller 10 stores the calculated position information in memory (in this example, storage 13) (S205). Then, controller 10 maps the object (in this example, wearable apparatus 200) to the calculated position on the stereoscopic sound space (on virtual space 300) (S206). Here, controller 10 maps the object on the virtual space 300, based on the coordinate system that was used for sound recognition in S107 above. As a result, a virtual sound source 103 is set on the virtual space 300.

After mapping the object on the virtual space 300, the controller 10 outputs sound from the speaker 17 (S207) as if the sound were output from the mapped position (i. e., the virtual sound source 103). Thus, the user can check whether the object has been mapped appropriately by comparing the sound output from the wearable apparatus 200 and the sound output from the speaker 17.

Note that, the controller 10 may determine whether the mapping is appropriate, based on whether the position of the virtual sound source 103 placed on the virtual space 300 by the mapping matches the position of the information terminal 102. The controller 10 may then automatically adjust the mapped position according to the result. That is, controller 10 may determine whether the direction of the information terminal 102 and the direction of the virtual sound source 103 are matched and adjust the position of the virtual sound source 103 according to the result (S208). Specifically, controller 10 determines the congruency of the direction of the sound, based on whether the discrepancy of the direction of the sound is within a predetermined threshold value. If controller 10 determines that the sound directions are not consistent, it adjusts the position information of wearable apparatus 200. Controller 10 stores the adjusted position information in memory (S205), performs mapping based on this position information again (S206), and adjusts the position of the virtual sound source 103.

The user then confirms the congruency of the sound direction between the information terminal 102 and the virtual sound source 103, and presses a button on the wearable apparatus 200 to stop the sound output (S209). Note that, as in S202 above, the user may stop the sound output of the wearable apparatus 200 by any appropriate method other than pressing the button.

In this way, the object is mapped on the virtual space 300 in the process from S201 to S206, and in the process from S207 to S209, a check is made as to whether the mapping is appropriate. The mapping process is then completed through the processes described below.

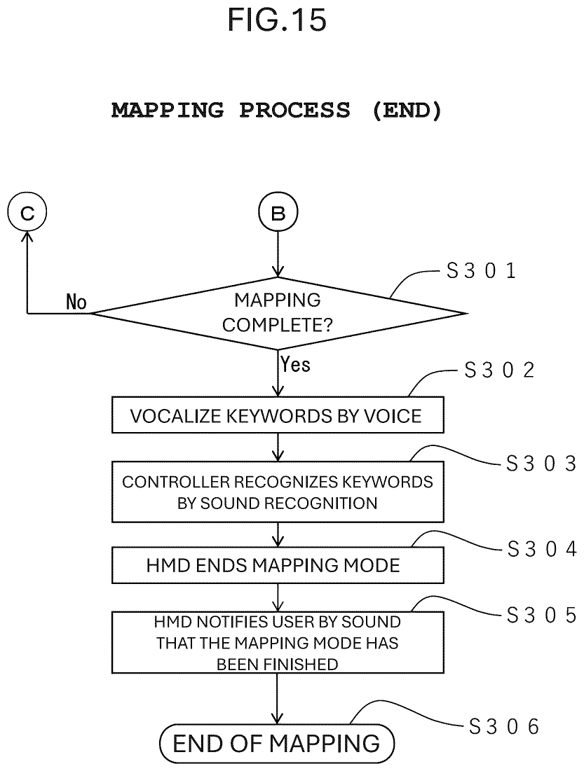

As shown in FIG. 15, the user checks whether there are no other objects to be mapped, and if there are other objects to be mapped, the user maps them using the method explained above (S301). If the user confirms that there are no other objects to be mapped, the user then utters a sound to sign the end of mapping (S302). Here, the user vocalizes “end of mapping” as an example. The controller 10 then performs sound recognition to recognize the keywords that sign the end of mapping (S303) and finishes the mapping mode (S304). The HMD 101 then outputs a sound to notify the user that the mapping mode has ended (S305). Here, the HMD 101 outputs, for example, a sound saying, “Mapping mode ends”.

In this way, after S301 through S305, the mapping process is completed (S306). Note that, the keywords and other data used by the HMD 101 for sound recognition in S301 to S305 may be stored in advance in an appropriate memory apparatus such as storage 13.

Note that, the HMD 101 may output a warning by sound when an attempt is made to map a position that has already been mapped in the virtual space 300. At that time, the HMD 101 may output a sound that suggests in which direction to shift the position of the object to be mapped. The HMD 101 may then use sound recognition to recognize keywords from the voice input by the user and shift the position of the object to be mapped in the specified direction. Here, the keywords (e.g., “left”, “right”, etc.) are stored in an appropriate memory apparatus. Also, the amount of displacement can be set as desired, but as an example, it can be the smallest amount that avoids overlapping. The controller 10 may then include this amount of misalignment and determine the congruency of the direction of the sound regarding S208 described above.

In addition, the HMD 101 can generate icons to indicate the mapped objects. Next, an example of a method in which the HMD 101 (specifically, the controller 10) generates an icon will be described.

The HMD 101 can use the sound output from the information terminal 102 in generating an icon for the object. In other words, data such as keywords indicating the object and sound output when the object is activated are stored in advance in the memory apparatus as using data for sound recognition. Then, the HMD 101 performs sound recognition based on the sound input from the information terminal 102 in S202, etc. described above, to determine the object for generating the icon.

Here, for example, if the object is the wearable apparatus 200, which is the information terminal 102, the sound output when the wearable apparatus 200 is activated in mapping mode is used as a keyword, and the HMD 101 may determine that the object of icon generation is the wearable apparatus 200 by recognizing this sound.

The HMD 101 then generates an icon for the identified object. Here, data such as the picture of the icon and the name of the icon may be stored in the memory apparatus, and controller 10 can generate an icon corresponding to the identified object based on this data. The controller 10 can also display the generated icon on the display 15, as will be described in detail later. At this time, the icon may be displayed with a name indicating the object.

An example of icon generation when the object is an application is also described. When the object is an application, data such as keywords indicating the application is stored in the memory apparatus, as in the example of the information terminal 102.

Here, for example, if the object is an application related to weather forecasting, sound that is keywords related to weather forecasting (e.g., “weather, sunny, cloudy, rain”) or sound that is output when the application is activated etc., may be stored in the memory apparatus. The HMD 101 then performs sound recognition based on the sound of the application input from the information terminal 102 in S202, etc., to determine the object for generating an icon.

Note that, although an example of identifying the object for generating an icon based on sound recognition was described here, the HMD 101 may acquire information for identifying the object by performing communication. The HMD 101 may, for example, acquire data for identifying the object (e.g., the information of name of the object) by communication with information terminal 102, and may use the acquired information to identify the object. Here, information associated with the information to be acquired through communication (e.g., a table whose records are information that can be acquired through communication and the name of the object) may be stored in the memory apparatus, and the HMD 101 may determine the object from the information acquired through communication by referring to this stored information.

The HMD 101 can then display the generated object icon on the display 15. Here, the controller 10 may, as an example, display the icon at a position corresponding to the mapped position on the virtual space 300, as a basis the wearing user. Note that, the display position of the icons can be moved appropriately by user operation, etc. The HMD 101, for example, may be configured so that the icons can be moved by user operation (by drag and drop) that selecting and moving the displayed icons. On the other hand, moving icons may be performed by voice input, as will be described in more detail later.

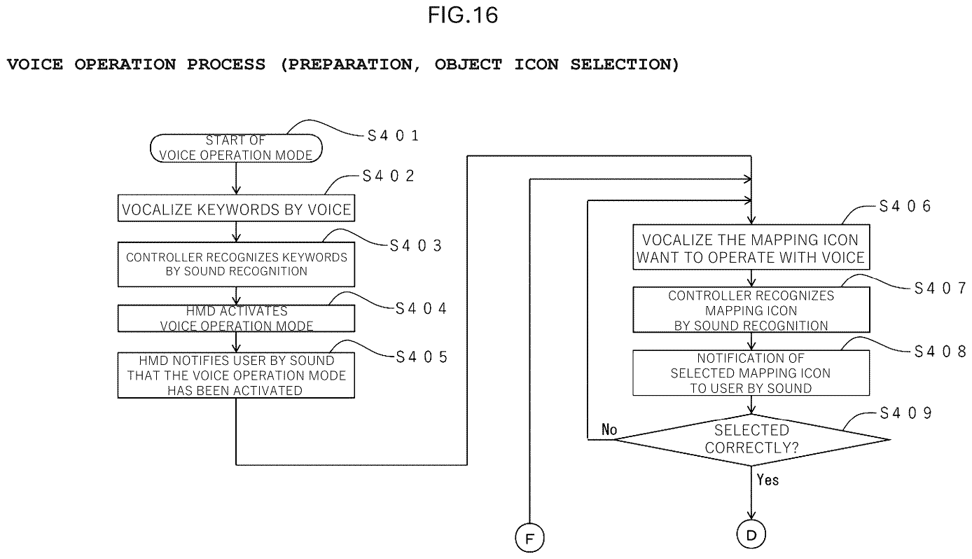

In the HMD 101, the object icons displayed on the display 15 are selectable by the user. The user can then select the object icon as appropriate and operate the mapped object. Next, the voice operation process using icons is explained with reference to the flowcharts shown in FIGS. 16 to 18. FIGS. 16 to 18 are flowcharts used to explain an example of voice operation processing.

As shown in FIG. 16, the HMD 101 waits until the user sign the start of the voice operation mode (a mode in which voice operation is possible) (S401). Then, by the user vocalizes a voice signaling the start of the voice operation mode (e.g., the user vocalizes “start operation”) (S402), controller 10 performs sound recognition to recognize the keywords that sign the start of the voice operation mode (S403). The HMD 101 (controller 10 in detail) then recognizes the keywords by sound recognition and activates the voice operation mode (S404). Here, the HMD 101 outputs a sound to notify that the voice operation mode has been activated (S405). the HMD 101, for example, notifies that “operation starts”.

In this way, in S401 to S405, the voice operation mode is activated, and preparations are made to perform voice operations. Then, the user can perform the voice operation of object as in the example described below. Note that, in the explanation below, the icon generated by mapping may be referred to as the mapping icon.

First, the user vocalizes the mapping icon of the object to be operated by voice (S406). As an example, if the user wants to select a smartphone 201 which is the mapped information terminal 102, the user vocalizes “smapho”. Then, controller 10 recognizes the mapping icon uttered by the user through sound recognition (S407). In other words, controller 10 selects the object mapping icon corresponding to the voice input by the user. Note that, the term “smapho” is an abbreviation for smart phone 201.

The HMD 101 then notifies the user of the selected mapping icon by sound (S408). Here, the HMD 101 notifies the user, for example, “You have selected a smapho”. From the content of the notification, the user confirms whether the selected mapping icon is correct or not, and if correct, vocalizes it is correct (e.g., vocalizes “OK”) (S409). By this, it enables the HMD 101 to recognize the keywords through sound recognition and perform the process of S501 described below. On the other hand, if the mapping icon is not correctly selected, the user vocalizes it is not correct (e.g., vocalizes “NO”). The user then vocalizes the mapping icon that he/she wants to operate once again, and causes the HMD 101 to perform the process of recognizing the mapping icon.

In this way, in S406 to S409, the mapping icon that the user wishes to voice-operate is selected. Note that, when the mapping icon is selected, a sound indicating that the mapping icon has been selected may be output. This sound may be a simple sound, such as “pop” for example, or it may be the name of the object indicated by the mapping icon. By this, the user enables to understand that the mapping icon has been selected.

Also, the sound indicating that a mapping icon has been selected may be output from the speaker 17 so that it is heard from the direction in which the selected mapping icon is displayed. As an example, if the selected mapping icon is displayed in front of the right eye of the user wearing the HMD 101, as a basis the center portion of the front side of the HMD 101, the sound may be output to be heard from the right side. Also, if the mapping icon is displayed on the center side of the HMD 101, sound may be output as if heard from the front side.

The HMD 101 may also use appropriate tracking technology in selecting the mapping icons. The HMD 101 may, for example, detect the direction of the user's head by the head tracker 28 in addition to the user's voice input to the microphone 16, and select the mapping icons for the voice input to the microphone 16 that is displayed in that direction. In this case, the user's desired mapping icon is selected by turning the head toward the direction of the mapping icon user want to be selected and vocalizing the voice.

Also, in addition to the user's voice input to the microphone 16, the HMD 101, for example, may detect the direction of the user's line of sight by the eye tracker 31 and select a mapping icon of the voice input to the microphone 16 that is displayed in that direction. In this case, the mapping icon desired by the user is selected by directing the user's line of sight to the mapping icon user want to be selected and vocalizing the voice.

In this way, by using tracking technique, the selection of mapping icons is achieved by including not only voice but also the user's movement and line of sight. Note that, in S401 to S409, data used for sound recognition such as keywords, may be stored in advance in an appropriate memory apparatus such as storage 13. Next, the voice operation process is described. This voice operation is performed via wireless communication with the information terminal 102 that performs the processing, based on voice input from the HMD 101 side.

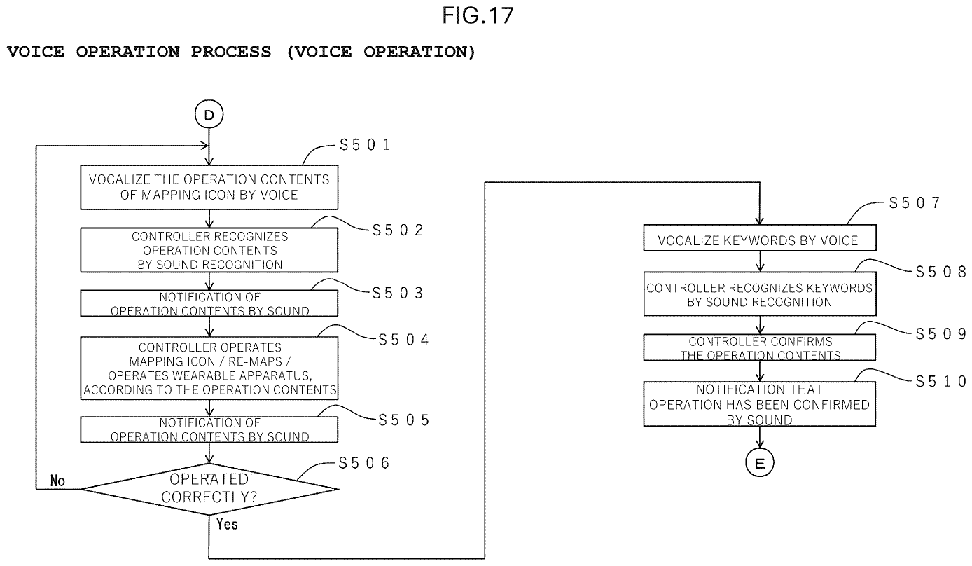

As shown in FIG. 17, the user vocalizes the operation contents of the selected object mapping icon (S501).

Here, various operations are considered as operation contents. As an example, operation content includes operation of related to the display (e.g., displaying menus and selecting menu items), displaying and moving of the cursor, adjusting the volume, operations related to outgoing and incoming calls when the object has a calling function (a function that processes voice in a call) such as smartphone 201, moving the displayed icon position (re-mapping), operating the information terminal 102 as the object, performing the object application (launching the application), and other. Note that, the HMD 101 can output sound from the object via the speaker 17 based on the virtual sound source on the virtual space 300. Also, if the information terminal 102 has a call function, the information terminal 102 may process the sound related to the call, and input and output sound during the call may be performed by the microphone 16 and speaker 17 of the HMD 101.

Then, controller 10 recognizes the operation contents by sound recognition (S502), and HMD 101 notifies the recognized operation contents by sound (S503).

When the user wants to move the mapping icon of the selected smartphone 201 to the left, as an example, the user vocalizes “move left”. The HMD 101 then recognizes that the mapping icon is to be moved to the left by sound recognition and notifies the user by sound, “move the smartphone to the left,” as an example. In this way, in S501 to S503, the operation contents are input to the HMD 101, and the HMD 101 recognizes the operation contents.

Then, controller 10 performs the operation according to the input operation content (S504) and notifies the performed operation content by sound (S505). When controller 10 performs the operation of moving the mapping icon of smartphone 201 to the left, as an example, controller 10 notifies the user by sound “The smartphone has been moved to the left”. Note that, the operation of controller 10 here is a pre-confirmation process, and the user determines whether the content of the operation is correct or not (S506). If the user determines that the content of the operation is correct, the process described below is performed and the content of the operation is confirmed. On the other hand, if the user determines that the operation is not correct, the operation content is input again. Note that, in this case, the operation content that the user determined to be incorrect is reset. In this way, in S504 to S506, the operation content inputted by the controller 10 is performed. Next, the process to confirm the operation content is described.

If the user determines that the operation is correct, the user inputs keywords indicate to that effect by voice (S507). The user vocalizes “OK” as an example. Then, controller 10 recognizes the keyword by sound recognition (S508) and to confirms the content of the operation (S509). The controller 10 then notifies the user by sound that the operation content has been confirmed (S510). When the mapping icon of smartphone 201 is confirmed to have been moved to the left as described above, controller 10 may, as an example, notify the user by sound, “move to the left is confirmed”.

In this way, the voice operation is finalized in S507 to S510. Here, in the voice processing operations from S501 to S510, data such as keywords used for sound recognition may be stored appropriately in memory apparatus such as storage 13, and the controller 10 may use this data in sound recognition.

Note that, in the voice operation, if a mapping icon overlaps with another mapping icon due to movement, the HMD 101 may output a warning by sound. The HMD 101 may then output a sound suggesting which direction to shift the mapping icon to be moved so that the mapping icons do not overlap. The HMD 101 can then use sound recognition to recognize keywords from the user's voice input and shift the position of the object to be mapped in predetermined direction. Here, the keywords (e.g., “left”, “right”, etc.) are stored in an appropriate memory apparatus. The amount of discrepancy can be set appropriately, but as an example, it can be the smallest amount that avoids overlapping.

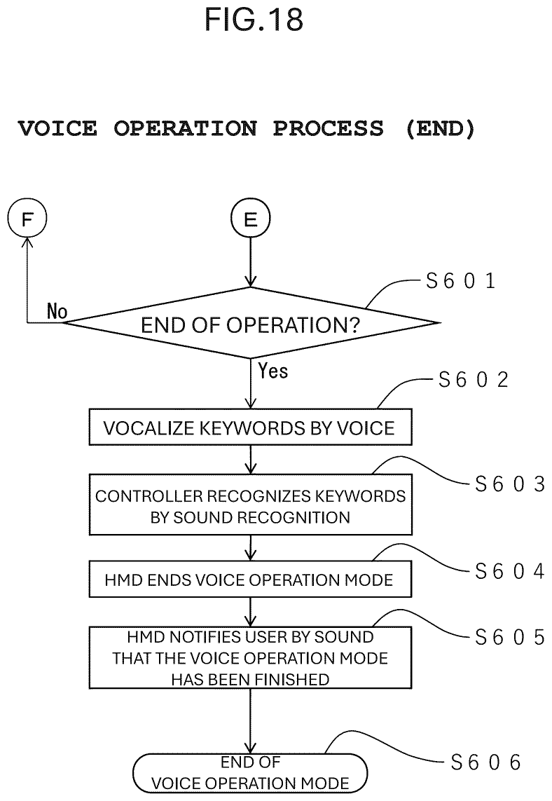

Next, an example of the process to end voice processing operations (i.e., processing to end voice operation mode) is described. As shown in FIG. 18, the user checks whether there is a mapping icon for which the user wants to perform voice operation (S601), and if there is no applicable mapping icon, the user vocalizes a keyword indicating that end voice operation (S602). The user vocalizes, for example, “End of operation”. The controller 10 then recognizes the keywords by sound recognition (S603), and the HMD 101 ends the voice operation mode (S604). The HMD 101 then notifies the user by sound that the voice mode has ended (S605). Here, the HMD 101 outputs, for example, a sound saying, “end the operation”.

In this way, after S601 to S605, the voice operation mode ends (S606). The keywords and other data used by the HMD 101 for sound recognition in S601 to S605 may be stored in advance in an appropriate memory apparatus such as storage 13.

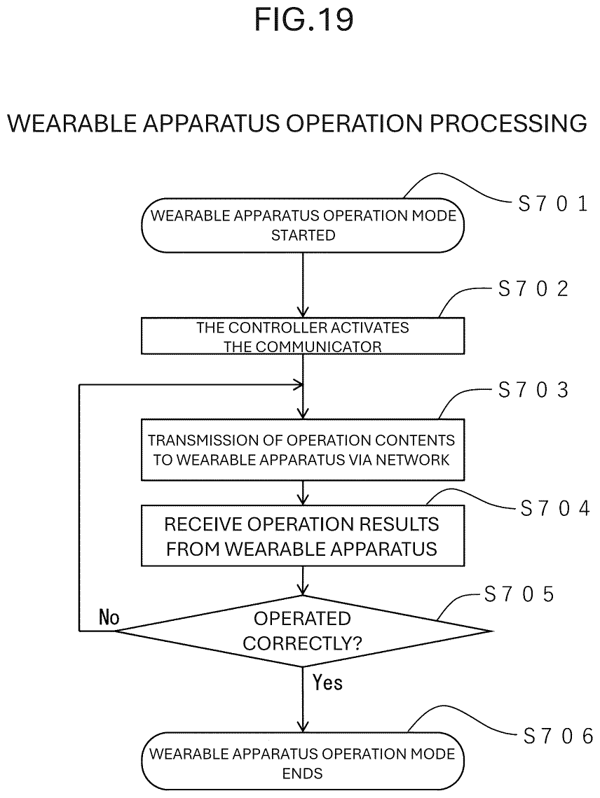

As explained above, the user can perform voice operations from the HMD 101 side to the information terminal 102. Here, with reference to FIG. 19, the input/output of data between the HMD 101 and the information terminal 102 in voice operation is explained.

First, the HMD 101 waits until there is a voice input by the user regarding the content of the operation, and when there is a voice input regarding the content of the operation, it starts the operation mode (in FIG. 19, the wearable apparatus operation mode) to the information terminal 102 (S701). Then, when the controller 10 voice-operates the information terminal 102 (i. e., when it recognizes the content of the operation to the information terminal 102 in the S502 process described above), it starts the communicator (communication processor 33 and interface 36) and starts communication with the information terminal 102 (in this example, the wearable apparatus 200) (S702).

The controller 10 then transmits the operation contents to the wearable apparatus 200 via the network 202 (S703) and receives the operation results from the wearable apparatus 200 (S704). The user then checks the received operation results to confirm whether the operation was performed correctly (S705). In other words, in S705, the confirmation of S506 explained above is performed. If the user confirms that the correct operation has been performed, a keyword to that effect is voice input by the user. Then, by the controller 10 confirms the operation, the operation mode to the information terminal 102 ends (S706).

According to this embodiment, the user can easily perform the mapping process of the object, generate icons of the object, and operate the object, based on the simple method of voice input. Thus, for example, the user can use it conveniently even when visibility to the outside world is limited. Also, according to this embodiment, an information terminal system comprises an HMD 101, which is an example of an audio augmented reality object reproduction apparatus, and one or more information terminals 102, is realized. Note that, in the above description, an example of a wearable apparatus 200 or a smartphone 201 is used is described, as an example of an information terminal 102, but the information terminal 102 may be a different other type of terminal. The information terminal 102 may also be a terminal that can be operated normally by means other than voice. In this case, such as input to the information terminal 102 signaling the start of mapping, may be performed by a method other than voice.

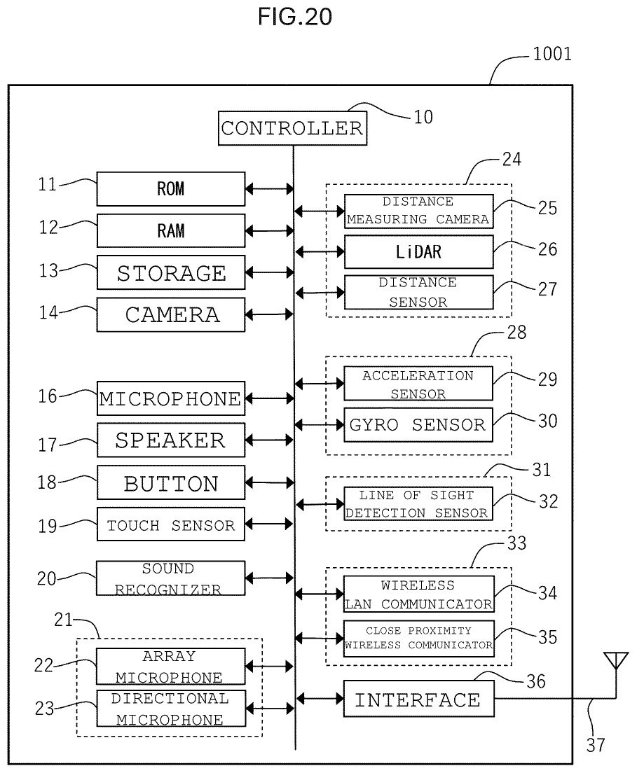

Next, the second embodiment is described with reference to FIG. 20. Functions similar to those of the other embodiments are marked with the same symbols and may be omitted from the description. The second embodiment describes an example of an audio augmented reality object reproduction apparatus 1001 in which the display 15 is omitted from the HMD 101 described in the first embodiment. In this audio augmented reality object reproduction apparatus 1001, processing related to the display is omitted.

The audio augmented reality object reproduction apparatus 1001 can be, as an example, an apparatus worn on the head like headphones. And, the audio augmented reality object reproduction apparatus 1001 is connected to the information terminal 102 and performs mapping on the virtual space 300 in response to sound input from the object in the same manner as described above. Also, by the user inputs the desired operation, the audio augmented reality object reproduction apparatus 1001 performs the processing corresponding to the user's operation. Here, the user can perform various operations, such as the operation to reproduce the mapped object, as described above. Also, in the case of reproducing the object, the audio augmented reality object reproduction apparatus 1001 can perform to output that sounds as if it is coming from the position of the virtual sound source 103 in the virtual space 300.

The first and second embodiments were described above. Here, the HMD 101 and audio augmented reality object reproduction apparatus 1001 described in the embodiments may be used stand-alone, without being connected to the information terminal 102. In this case, the HMD 101 and audio augmented reality object reproduction apparatus 1001 perform mapping using sound from the information terminal 102 and processing in response to operations from the user, as described above, but the process of using communication with the information terminal 102 is omitted.

In the case of reproducing the mapped object, the HMD 101 and the audio augmented reality object reproduction apparatus 1001 store the data to be reproduced from the object to be mapped in advance, and the HMD 101 and the audio augmented reality object reproduction apparatus 1001 performs to output that sounds as if it is coming from the position corresponding on the virtual space 300, based on the stored data in advance.

Note that, the audio augmented reality object reproduction apparatus (101, 1001) may be configured for stand-alone use only, in this case, the configuration for communicating with the information terminal 102 may be omitted. Also, the information terminal 102 may be a terminal in which the configuration used for communication is omitted.

The embodiment of the present invention has been described above, needless to say, configurations to realize the technology of the invention is not limited to the above embodiments, various modifications can be considered. For example, the aforementioned embodiments are described in detail in order to explain the invention in an easy-to-understand manner, and are not necessarily limited to those having all the described configurations. It is also possible to replace some of the configurations of one embodiment with those of another embodiment, and it is also possible to add configurations of other embodiments to those of one embodiment. All of these are within the scope of the invention. In addition, the numerical values, messages, etc. that appear in the text and figures are only examples, and it does not impair the effect of the invention when the use of different ones.

The programs described in each processing example may be independent programs, or multiple programs may constitute a single application program. In addition, the order in which each process is performed may be interchanged.

The functions, etc., of the invention described above may be realized in hardware, for example, by designing some or all of them in integrated circuitry. They may also be implemented in software by a microprocessor unit, CPU, or the like, interprets and executes an operating program that realizes the respective functions, etc. Also, the scope of software implementation is not limited, and hardware and software may be used together. In addition, part or all of each function may be realized by a server. Note that, the server may be a local server, a cloud server, an edge server, a network service, etc., as long as it is capable of executing functions in cooperation with other configures via communication, the form does not matter. Information such as programs, tables, and files that realize each function may be stored in memory apparatus such as, memory, hard disks, SSD (Solid State Drive), in recording apparatus, such as IC cards, SD cards, and DVD, or in apparatus on the communication network.

Also, the control and information lines shown in the figure are those considered necessary for illustrative purposes and do not necessarily represent all the control and information lines on the product. In reality, almost all of the configures may be considered to be interconnected.

### REFERENCE SIGNS LIST

10 controller (processor)
11 ROM
12 RAM
13 storage
14 camera
15 display (display)
16 microphone
17 speaker
18 button
19 touch sensor
20 sound recognizer
21 sound inputter
22 array microphone
23 directional microphone
24 distance measurer
25 distance measuring camera
26 LiDER
27 distance sensor
28 head tracker
29 acceleration sensor
30 gyro sensor
31 eye tracker
32 line of sight detection sensor
33 communication processor
34 wireless LAN communicator
35 close proximity wireless communicator
36 interface
37 wireless antenna
100 operator (user)
101 HMD (head mounted display)
102 information terminal
103 virtual sound source
200 wearable apparatus
201 smartphone
202 network
300 virtual space
1001 audio augmented reality object reproduction apparatus

1. An audio augmented reality object reproduction apparatus capable of mapping an object in virtual space, comprising:
a processor;
wherein the processor, based on a sound output and input from an information terminal, maps the information terminal or an application of the information terminal as an object, to a location in the virtual space corresponding to a location of the information terminal.

2. The audio augmented reality object reproduction apparatus according to claim 1, further comprising an array microphone to input the sound from the information terminal,
wherein the array microphone comprises (1) microphones located at upper left end portion and lower right end portion of a front side of the audio augmented reality object reproduction apparatus and at right side of the audio augmented reality object reproduction apparatus, or (2) microphones located at upper right end portion and lower left end portion of the front side of the audio augmented reality object reproduction apparatus and at left side of the audio augmented reality object reproduction apparatus.

3. The audio augmented reality object reproduction apparatus according to claim 2, wherein
in the array microphone,
in the case of the configuration (1) above, when the audio augmented reality object reproduction apparatus is worn, the microphones are arranged so that a distance between each microphone on the front side is approximately the same as a distance between the microphone on the lower right end portion of the front side and the microphone on the right side,
in the case of the configuration (2) above, when the audio augmented reality object reproduction apparatus is worn, the microphones are arranged so that a distance between each microphone on the front side is approximately the same as a distance between the microphone on the lower left end portion of the front side and the microphone on the left side.

4. The audio augmented reality object reproduction apparatus according to claim 1, further comprising one or more directional microphones that input sound from the information terminal.

5. The audio augmented reality object reproduction apparatus according to claim 1, wherein
the processor determines as to whether the mapping is appropriate, based on whether a location of the virtual sound source positioned by the mapping matches the location of the information terminal that outputs the sound.

6. The audio augmented reality object reproduction apparatus according to claim 5, wherein
the processor adjusts the position of the virtual sound source as to match the position of the information terminal, when it determines that the mapping is not appropriate.

7. The audio augmented reality object reproduction apparatus according to claim 1, wherein
the processor causes a warning by sound to be output, when a location of an object to be mapped overlaps with a location of another object already mapped in the virtual space.

8. The audio augmented reality object reproduction apparatus according to claim 7, wherein
the processor outputs a sound suggesting a direction in which to shift the position to map the object.

9. The audio augmented reality object reproduction apparatus according to claim 1, wherein
the processor outputs a sound that allows a user to select whether to use a local coordinate system or a world coordinate system for mapping, and
performs mapping in the coordinate system corresponding to the input sound of user.

10. The audio augmented reality object reproduction apparatus according to claim 1, further comprising a display, wherein
the processor displays an icon used to operate the mapped object on the display.

11. The audio augmented reality object reproduction apparatus according to claim 10, wherein
the processor selects the icon of the object corresponding to a sound input by a user.

12. The audio augmented reality object reproduction apparatus according to claim 11, further comprising a head tracker that detects the user's head movements,
the processor selects an icon for a direction to be detected by the head tracker.

13. The audio augmented reality object reproduction apparatus according to claim 11, further comprising an eye tracker that detects the user's line of sight direction,
the processor selects an icon for the direction to be detected by the eye tracker.

14. The audio augmented reality object reproduction apparatus according to claim 10, wherein
the processor displays a name of the object to be acquired based on the sound from the information terminal, together with the icon of the object on the display.

15. The audio augmented reality object reproduction apparatus according to claim 10, further comprising an interface that is used to communication,
the processor displays a name of the object to be acquired based on the communication with the information terminal, together with the icon of the object on the display.

16. An information terminal system comprising:
one or more information terminals; and
an audio augmented reality object reproduction apparatus capable of mapping an object in virtual space,
wherein the audio augmented reality object reproduction apparatus includes a processor,
wherein the processor, based on a sound output and input from the information terminal, maps the information terminal or an application of the information terminal as an object, to a location in the virtual space corresponding to a location of the information terminal.

17. The information terminal system apparatus according to claim 16,
wherein the audio augmented reality object reproduction apparatus includes a display,
wherein the processor displays an icon used to operate the mapped object on the display.

18. The information terminal system apparatus according to claim 17, wherein
the processor selects the icon of the object corresponding to a sound input by a user.

19. The information terminal system apparatus according to claim 17, wherein
the processor displays a name of the object to be acquired based on the sound from the information terminal, together with the icon of the object on the display.

20. The information terminal system apparatus according to claim 17, further comprising an interface that is used to communication,
wherein the processor displays a name of the object to be acquired based on the communication with the information terminal, together with the icon of the object on the display.
